(19) United States
(12) Patent Application Publication
(10) Pub. No.: US 2019/0291335 A1
(43) Pub. Date: Sep. 26, 2019

(54) WINDING CORE AND METHOD FOR PRODUCING BLADE ENDS, MOLD AND METHOD FOR PRODUCING TRAILING EDGE SEGMENTS, WIND TURBINE, ROTOR BLADE SERIES, ROTOR BLADE AND METHOD FOR PRODUCING SAME

(71) Applicant: Wobben Properties GmbH, Aurich (DE)

(72) Inventor: Alexander HOFFMANN, Emden (DE)

(21) Appl. No.: 16/302,305

(22) PCT Filed: May 23, 2017
(86) PCT No.: PCT/EP2017/062397

§ 371 Date: Nov. 16, 2018

(30) Foreign Application Priority Data
May 26, 2016 (DE) 10 2016 109 761.6

(51) Int. Cl. B29C 53/82; B29C 53/58; B29C 33/30; F03D 1/06

(52) U.S. Cl. CPC B29C 53/824; B29C 53/582; B29L 2031/085; F03D 1/0683; B29C 33/301

(57) ABSTRACT

A winding core for producing blade ends for rotor blades of wind power installations and to a mold for producing trailing edge segments is provided. Methods for producing a blade end, for producing a trailing edge segment and for producing a rotor blade and also to a rotor blade and a rotor blade series are provided. The winding core comprises a first section with a first end for forming a hub connection geometry for connecting the blade end to a rotor hub, and a second section with a second end for forming an outer blade connection geometry for connecting the blade end to an outer blade, wherein it is possible by exchanging or completely or partially removing the first section to vary a longitudinal extent of the winding core and/or a diameter of the first section and/or a shape of the first section such that blade ends produced therewith are suitable for wind power installations with different rotor diameters.

### BACKGROUND

### Technical Field

The invention relates to a winding core for producing blade ends for rotor blades of wind power installations and to a mold for producing trailing edge segments for rotor blades of wind power installations, in particular for blade ends of rotor blades of wind power installations. The invention also relates to a method for producing a blade end of a rotor blade of a wind power installation, to a method for producing a trailing edge segment for a rotor blade of a wind power installation, in particular for a blade end of a rotor blade of a wind power installation, and to a method for producing a rotor blade of a wind power installation. The invention also relates to a rotor blade for a wind power installation, to a wind power installation and also to a rotor blade series for wind power installations.

### Description of the Related Art

Wind power installations are known and the currently most common type of wind power installation is a so-called horizontal-axis wind power installation, usually with three rotor blades. The dimensions of such wind power installations are getting bigger and bigger, that is to say in particular they have higher hub or axis heights and greater rotor diameters with a correspondingly larger generator and greater feed-in power. Greater rotor diameters mean longer rotor blades, which have to be transported from where they are manufactured to the respective erection site and installed there. DE 10 2014 206 670 A1 discloses for example a divided rotor blade with a rotor blade inner part or a rotor blade end and a rotor blade outer part or outer blade. Also, DE 10 2013 204 635 A1 discloses a device and a method for producing blade ends by a winding process. A device for producing rotor blade shells of various sizes and shapes is known from DE 10 2014 001 445 B4.

Greater rotor diameters with longer rotor blades impose high requirements on the production of these rotor blades, their design, in particular with regard to aerodynamics, and also their load-bearing capacity. In particular, the development and production of rotor blades for wind power installations with different rotor diameters, in particular with increasing rotor diameters, involves great expenditure in terms of time and costs.

The German Patent and Trademark Office has searched the following prior art in the priority application for the present application: DE 43 35 221 C1, DE 10 2014 001 445 B4, DE 10 2008 055 580 A1, DE 10 2013 204 635 A1 and DE 10 2014 206 670 A1.

### BRIEF SUMMARY

Provided is a solution with which the cost-effectiveness is improved and/or the expenditure on the design and/or the production and/or transport of rotor blades is reduced.

Provided is a winding core for producing blade ends for rotor blades of wind power installations, comprising a first section with a first end for forming a hub connection geometry for connecting the blade end to a rotor hub, and a second section with a second end for forming an outer blade connection geometry for connecting the blade end to an outer blade, wherein it is possible by exchanging or completely or partially removing the first section to vary a longitudinal extent of the winding core and/or a diameter of the first section and/or a shape of the first section such that blade ends produced therewith are suitable for wind power installations with different rotor diameters.

The winding core has a first section and a second section, which are preferably detachably connectable or connected to one another. The second section can be exchanged or completely or partially removed. In this way, the winding core can be used for producing blade ends that are suitable for different rotor blade diameters of wind power installations. For this purpose, by exchanging or completely or partially removing the first section, the winding core is varied, in particular with regard to its longitudinal extent and/or its diameter, for example its inner diameter and/or its outer diameter and/or its shape. Such varied or modified winding cores have the effect that correspondingly different blade ends are then created. The variation of the winding core is in this case realized in such a way that the blade ends produced therewith are suitable for wind power installations with different rotor diameters, in particular have different longitudinal extents.

This can be realized in particular by a first blade end, which is produced with the first and second sections of the winding core, being suitable for a first wind power installation with a first rotor diameter and a second blade end, which is produced with a winding core with an exchanged or completely or partially removed first section, being suitable for a second wind power installation with a second rotor diameter, the second rotor diameter being different from the first rotor diameter. Preferably, the two blade ends produced in this way have a different longitudinal extent, so that, even with a combination of the two blade ends with identically formed outer blades, different rotor blades are created, in particular rotor blades with a different longitudinal extent.

The invention is based inter alia on the realization that an adaptation of rotor blades to different rotor diameters, in particular in the case of divided rotor blades, can be realized particularly cost-effectively and with reduced expenditure by a modification of the blade end. In particular, a variation of the longitudinal extent and/or of the diameter, in particular the inner and/or outer diameter, in particular at a first end, toward the rotor hub, of the blade end, and/or of the shape of the blade end can allow and/or facilitate an adaptation of a rotor blade that has such a blade end to different rotor diameters.

A winding core is generally used for being wound with a fiber composite material, which is preferably formed as a web and/or produced in the form of a web. For this purpose, the winding core generally rotates, preferably driven by a motor, while the fiber composite material is being fed to the winding core. Also, the winding core and/or the fiber composite material preferably performs a translational movement in the direction of the longitudinal extent of the winding core during the winding, in order to wind around the winding core along its entire longitudinal extent, since the longitudinal extent of the winding core is generally wider than the width of the web of the fiber composite material.

Preferably, the fiber composite material is impregnated with a matrix material, for example in an impregnating device. In this stage, the matrix material is preferably liquid and/or flowable. Preferably, the fiber composite material impregnated with matrix material is cured after completion of the winding, so as to create a cured fiber composite blade end, which can then be removed from the winding core. The blade end may be connected to one or more attachment parts, such as for example an outer blade and/or a trailing edge segment and/or a blade tip, in order to form a rotor blade. For this purpose, the blade end preferably has a hub connection geometry on the end face that is facing toward the rotor hub in the installed state. The blade end preferably also has an outer blade connection geometry, which is preferably arranged on the end face that is facing away from the rotor hub and toward the outer blade in the installed state.

A blade end and/or a trailing edge segment and/or an outer blade may also be referred to as a semifinished rotor blade part.

The connection geometries of the blade end are dictated inter alia by the shape of a first end and a second end of the winding core. The first end of the winding core is preferably used for forming the hub connection geometry of the blade end and a second end of the winding core is preferably used for forming the outer blade connection geometry of the blade end.

The winding core according to the invention has the advantage that various blade ends, and consequently also various rotor blades, can be produced with a winding core, whereby wind power installations with various rotor diameters can be realized quickly, flexibly and/or inexpensively, in particular even at different, sometimes remote, locations.

As a consequence of using the same, though variable, winding core, and in particular if the same outer blades are used for producing the rotor blades with different longitudinal extent, there can be great effects of series production or mass manufacture, which can have advantages in terms of cost and quality. Furthermore, such a configuration has advantages with regard to low expenditure on modification and low expenditure on supervising series production, low expenditure on certification, lower expenditure on tests and inspections and also low expenditure on supervising prototypes. The area taken up in production facilities can also be reduced, since many different blade ends can be produced with one winding core, and it is not necessary for a separate winding core to be kept for each different blade end. Expenditure can also be significantly reduced in the construction and design of (new) rotor blades and blade ends. Finally, advantages are also obtained in transport and logistics.

According to a preferred embodiment of the winding core, it is provided that, with the complete removal of the first section, a first end of the second section is used for forming the hub connection geometry. For producing another variant of a blade end, in particular for producing a blade end with a shortened longitudinal extent, the first section of the winding core can be removed. In this case, the first end of the second section, which is preferably opposite from the second end of the second section, is used for forming the hub connection geometry of a blade end. In this case, the blade end extends essentially from the first end to the second end of the second section of the winding core. Since the second end of the second section is used for forming the outer blade connection geometry, in this case the first end of the second section, which is preferably opposite from the second end, is used for forming the hub connection geometry.

It is also preferably provided that the first section has two, three or more winding core segments. The two, three or more winding core segments are preferably arranged one behind the other in the longitudinal direction. It is also preferred that the two, three or more winding core segments are detachably connected in the longitudinal direction to their respectively neighboring winding core segment or their respectively neighboring winding core segments. This arrangement of the winding core segments and/or the detachability of the connection between neighboring winding core segments has/have the advantage that the first section of the winding core can be entirely or partially removed, or if appropriate entirely or partially added again after a previous removal, easily, quickly and inexpensively.

It is also preferably provided that, with the removal of one or more winding core segments, a first end of a remaining winding core segment is used for forming the hub connection geometry. Also in this case, a blade end with in particular a shortened longitudinal extent can preferably be produced by the removal of one or more winding core segments. Used in this case for forming the hub connection geometry is the first end of that remaining winding core segment that lies furthest away from the second section, i.e., that is opposite from the second end of the second section that is used for forming the outer blade connection geometry and, in particular for a shortened winding core, represents the first end of this shortened winding core opposite from the second end.

In a further preferred development, it is provided that the first end of the second section corresponds to the first end of the first section and/or that the first end of one or more or all of the winding core segments corresponds to the first end of the first section.

This embodiment has the advantage that different blade ends can be produced, but they have the same hub connection geometry.

Preferably, the first end of the second section and the first end of the first section or the first end of one, more or all of the winding core segments correspond with regard to their diameter, in particular their inner and/or outer diameter and/or with regard to their shape.

With this embodiment, blade ends that are different with regard to their longitudinal extent but identical and/or compatible and/or exchangeable with regard to their hub connection geometry can be produced in particular.

According to a further preferred embodiment, the first portion and/or the second portion is/are formed essentially rotationally symmetrically. This is preferred in particular to realize and/or facilitate the winding of a blade end by rotation of the winding core. An elliptical shape for example is also understood here as a rotationally symmetrical shape.

It is also preferred that the first section has an essentially cylindrical shape. Since the first section of the winding core is generally used for forming a section of the blade end near the hub, and also this first section can be exchanged or partially or completely removed, a cylindrical formation is preferred, in particular a formation with a circular cross section orthogonal to the longitudinal extent.

Also, the second section may have an essentially cylindrical and/or essentially frustoconical shape. A configuration of the second section as essentially cylindrical has the advantage that the entire winding core is formed essentially cylindrically, thereby creating blade ends of which the inner cavity is formed essentially cylindrically, in particular over the entire longitudinal extent of the blade end. Alternatively, it may be preferred to form the second section essentially frustoconically. In this embodiment, the winding core preferably tapers toward the second end of the second section. It may also be preferred that the shape of the second section of the winding core deviates from an ideal frustoconical shape, and the lateral surface of the truncated cone is formed as curved, so that in the cross section orthogonal to the longitudinal extent of the winding core the outer edges of the truncated cone are not straight. Combinations between a cylindrical shape and a frustoconical shape in the second section may also be preferred.

According to a further aspect of the invention, provided is a mold for producing trailing edge segments for rotor blades of wind power installations, in particular for blade ends of rotor blades of wind power installations, with which it is possible by exchanging and/or removing and/or adding one or more mold segments to vary a longitudinal extent of the mold and/or a shape of the mold and/or a maximum extent of the mold orthogonal to the longitudinal extent in such a way that trailing edge segments produced therewith are suitable for rotor blades for wind power installations with different rotor diameters.

The problematic issues presented above with reference to a blade end of a rotor blade and the advantageous aspects of the winding core according to the invention also apply correspondingly to the trailing edge segments intended for such different rotor blades for wind power installations with different rotor blade diameter. A trailing edge segment is generally used for improving a rotor blade with regard to its aerodynamics. In the case of divided rotor blades, the trailing edge segment is generally fastened at least at the blade end, generally in the radial direction. In order to replicate the variation of the blade ends that can be produced with the modifiable winding core also with respect to the trailing edge segment, or if appropriate also to increase the variation, it is of advantage if different trailing edge segments can be created quickly, easily and inexpensively. The provision of a mold for producing trailing edge segments that can be modified by exchanging and/or removing and/or adding one or more mold segments has advantages corresponding to the advantages mentioned above with reference to the winding core. In particular, it is preferred that, by exchanging and/or removing and/or adding one or more mold segments, a longitudinal extent of the mold and/or a shape of the mold and/or a maximum extent of the mold orthogonal to the longitudinal extent, in particular in the radial and/or tangential direction, can be modified. Accordingly, the trailing edge segments produced with this mold also vary, in particular with regard to their longitudinal extent and/or their shape and/or their maximum extent orthogonal to the longitudinal extent, in particular in the radial and/or tangential direction, with respect to the rotor blade, in particular the blade end.

According to a further aspect of the invention, provided is a method for producing blade ends for rotor blades of wind power installations, comprising: providing a winding core described here, winding fiber composite material and a matrix material onto the winding core, curing the matrix material.

For producing a blade end with a winding core, as also at least partially already described above, first a winding core described here is provided. In particular, it is preferred that, for producing a blade end that is suitable for a rotor of a wind power installation with a specific rotor diameter, the winding core is adapted to the rotor diameter, in particular with regard to the longitudinal extent of the rotor blade desired for the rotor diameter, by exchanging, completely or partially removing the first section. Fiber composite material and matrix material are wound onto the winding core, the fiber composite material preferably being provided in web form and impregnated with a liquid and/or flowable matrix material. Preferably, following the winding, the matrix material is cured, so that a cured fiber composite blade end is created. Preferably, after the curing, the winding core is removed from the cured fiber composite blade end.

According to a further aspect of the invention, provided is a method for producing trailing edge segments for rotor blades of wind power installations, in particular for a blade end of a rotor blade of a wind power installation, comprising: providing a mold described here, introducing fiber composite material and matrix material into the mold, curing the matrix material.

For the production of trailing edge segments, a mold for producing trailing edge segments as described herein is provided, into which fiber composite material and matrix material are introduced. Preferably, after the curing of the matrix material, the cured trailing edge segment can be removed from the mold. For producing a trailing edge segment that is suitable for a wind power installation with a specific rotor diameter, the mold is preferably adapted to the rotor diameter, in particular by exchanging and/or removing and/or adding one or more mold segments.

According to a further aspect of the invention, provided is a method for producing a rotor blade for a wind power installation, comprising: providing a blade end that is produced by using a winding core described here and/or by a method described here, connecting the blade end to one or more attachment parts, such as for example a trailing edge segment, preferably a trailing edge segment that is produced by using a mold described here and/or by a method described here, and/or an outer blade and/or a blade tip.

A rotor blade is produced by providing a blade end described herein and, preferably after its curing, connecting it to one or more attachment parts to form a rotor blade or a further semifinished part for a rotor blade, for example a combination of a blade end with a trailing edge segment, which then still has to be connected to an outer blade. The trailing edge segment is also preferably formed as described herein. Altogether, it is preferred that the blade end and/or the trailing edge segment are produced by modifying the winding core and/or the mold in such a way that they are suitable for a specific rotor diameter. Also the outer blade may preferably be coordinated with the specific rotor diameter. The connection between the blade end and the one or more attachment parts is preferably performed by means of screwing and/or adhesive bonding.

According to a further aspect of the invention, provided is a rotor blade for a wind power installation, comprising a blade end that is produced by using a winding core described herein and/or by a method described herein and also one or more attachment parts connected to the blade end, for example a trailing edge segment, preferably a trailing edge segment that is produced by using a mold described herein and/or by a method described herein, and/or an outer blade and/or a blade tip.

Preferably, the outer blade has a blade end connection geometry for connecting the outer blade to the outer blade connection geometry of the blade end. Also preferably, the outer blade is connected to the blade end by way of a connection of the blade end connection geometry to the outer blade connection geometry of the blade end.

Preferably, the rotor blade also comprises a trailing edge segment that is produced by using a mold described herein and or by a method described herein for producing a trailing edge segment.

Provided is a wind power installation comprising at least one rotor blade described herein. In particular, it is preferred that the wind power installation comprises a tower and a nacelle rotatably mounted on the tower, a rotor with a plurality of rotor blades, preferably three rotor blades, preferably being rotatably mounted on the nacelle. Provided is a rotor blade series for wind power installations, comprising a first blade end that is produced by using a winding core described herein and/or by a method described herein, a second blade end that is produced by using a winding core described herein and/or by a method described herein, a first outer blade and a second outer blade, the first blade end being connectable and/or connected to the first outer blade to form a first rotor blade and the second blade end being connectable and/or connected to the second outer blade to form a second rotor blade, and the first rotor blade being suitable for a wind power installation with a first rotor diameter and the second rotor blade being suitable for a wind power installation with a second rotor diameter, the first rotor diameter being different from the second rotor diameter.

A rotor blade series according to the invention is distinguished by the fact that two blade ends are produced by the method described here and/or with the winding core described here and are connectable or connected to two outer blades. The two rotor blades thereby created differ to the extent that they are suitable for wind power installations with different rotor diameters. This differentiation of the two rotor blades is preferably achieved in particular by a different configuration of the two blade ends, which is created by a variation of the winding core described herein. In particular, a different configuration of the two blade ends with regard to their longitudinal extent is preferred. In this way, two different rotor blades that differ in particular in their longitudinal extent can be produced even when using two identically formed outer blades.

The rotor blade series is generally not fitted on a single wind power installation, but on different wind power installations, which differ with regard to their rotor diameter.

According to a preferred development of the rotor blade series, it is provided that the first rotor blade, in particular the first blade end, has a first trailing edge segment that is produced by using a mold described herein and/or by a method described herein for producing a trailing edge segment. It is also preferred that the second rotor blade, in particular the second blade end, has a second trailing edge segment that is produced by using a mold described herein and/or by a method described herein for producing a trailing edge segment.

In a preferred development of the rotor blade series, the first outer blade and the second outer blade are formed identically or differently. The identical formation of the two outer blades has the advantage that a smaller number of different outer blades has to be kept in order to create different rotor blades.

In an extreme case, a rotor blade series for two, three or more different rotor blade diameters can be formed even with only a single type of outer blades, by variation of the blade ends and/or trailing edge segments. Furthermore, the outer blades may also be differently formed, in particular with regard to their longitudinal extent and/or their shape and/or their blade tip and/or further features. By the combination of different outer blades with different blade ends and/or different trailing edge segments, a particularly differentiated rotor blade series can be formed.

According to a further embodiment, the rotor blade series has more than two blade ends and more than two outer blades, from which more than two rotor blades are formed. Preferably, also more than two trailing edge segments may be provided here. In such a rotor blade series, it may be preferred to form all of the outer blades identically or differently. Particularly preferred however is a rotor blade series in which some of the outer blades are identically formed and other outer blades are differently formed. It may particularly be preferred to provide groups of identically formed outer blades that respectively differ from other groups of outer blades.

A rotor blade series in which the first trailing edge segment and the second trailing edge segment are formed identically or differently may also be preferred. Here, too, in rotor blade series in which three or more trailing edge segments are provided, all of these trailing edge segments may be identically formed or all of these trailing edge segments may be differently formed. It may however also be preferred to form only some of the trailing edge segments differently and to form other trailing edge segments identically, in particular to identically form groups of trailing edge segments that differ from groups of other trailing edge segments.

For the advantages, configurational variants and configurational details of these further aspects of the invention and their respective developments, reference is also made to the description otherwise of the corresponding advantages, configurational variants and configurational details of the other aspects respectively.

### BRIEF DESCRIPTION OF THE SEVERAL VIEWS OF THE DRAWINGS

Preferred embodiments of the invention are described by way of example on the basis of the accompanying figures, in which:

FIG. 1 shows a schematic representation of a wind power installation;

FIG. 2A shows a schematic side view of a first embodiment, given by way of example, of a winding core;

FIG. 2B shows a winding core that is shortened in comparison with the variant represented in FIG. 2A;

FIG. 2C shows a winding core that is shortened further in comparison with the variant represented in FIG. 2B;

FIG. 3A shows a first embodiment, given by way of example, of a blade end with a trailing edge segment;

FIG. 3B shows a further embodiment, given by way of example, of a blade end with a trailing edge segment;

FIG. 3C shows a further embodiment, given by way of example, of a blade end with a trailing edge segment;

FIG. 4A shows a first embodiment, given by way of example, of a rotor blade with a blade end, a trailing edge segment and an outer blade;

FIG. 4B shows a further embodiment, given by way of example, of a rotor blade with a blade end, a trailing edge segment and an outer blade; and

FIG. 4C shows a further embodiment, given by way of example, of a rotor blade with a blade end, a trailing edge segment and an outer blade.

### DETAILED DESCRIPTION

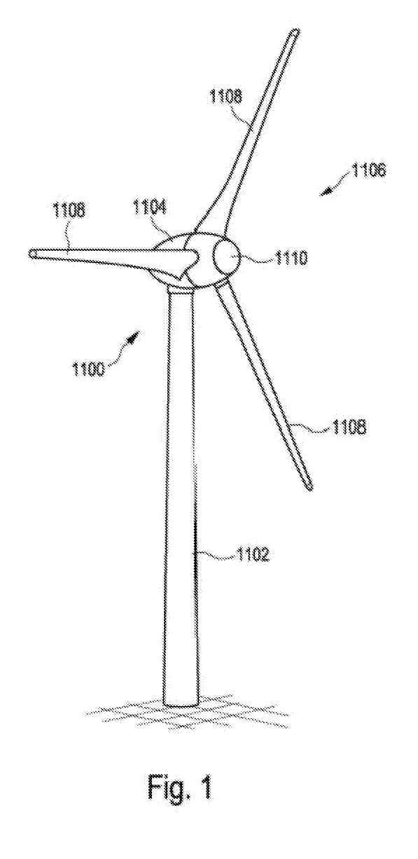

FIG. 1 shows a wind power installation 1100 with a tower 1102 and a nacelle 1104. Arranged on the nacelle 1104 is a rotor 1106 with three rotor blades 1108 and a spinner 1110. During operation, the rotor 1106 is set in a rotary motion by the wind, and thereby drives a generator in the nacelle 1104.

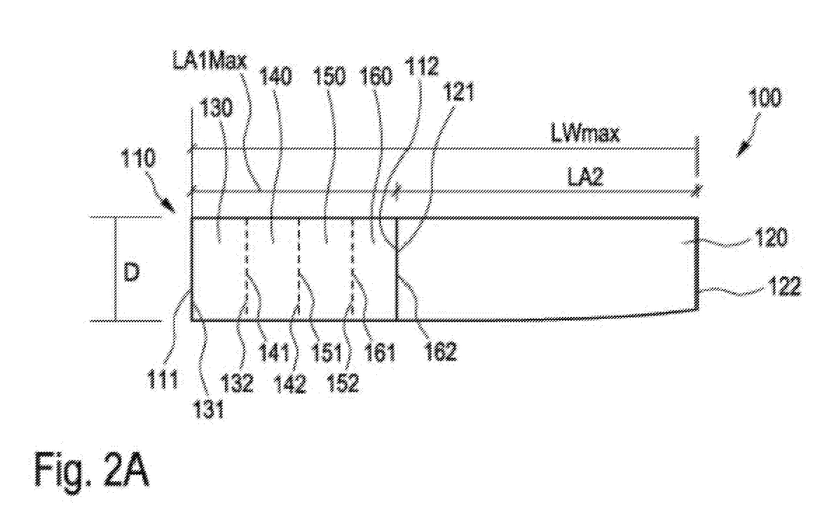

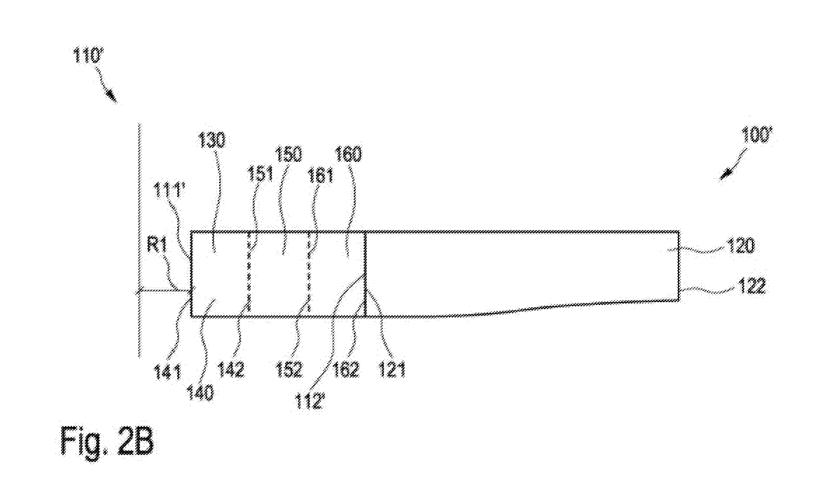

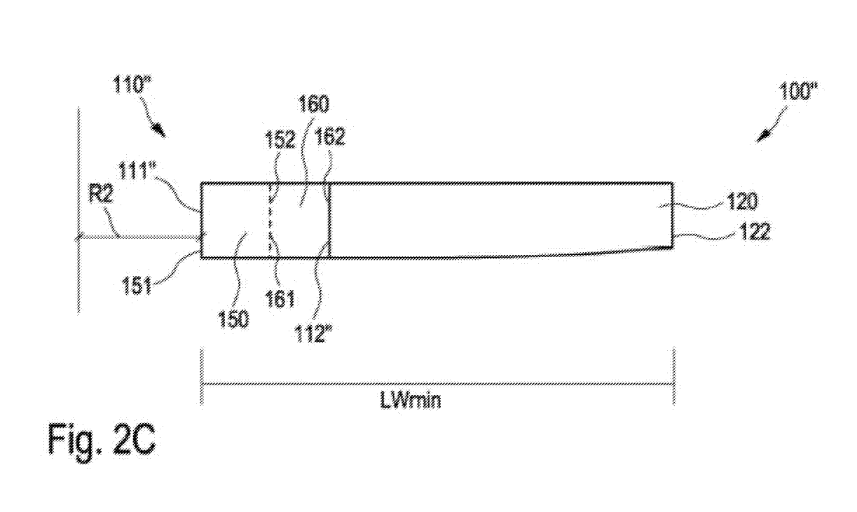

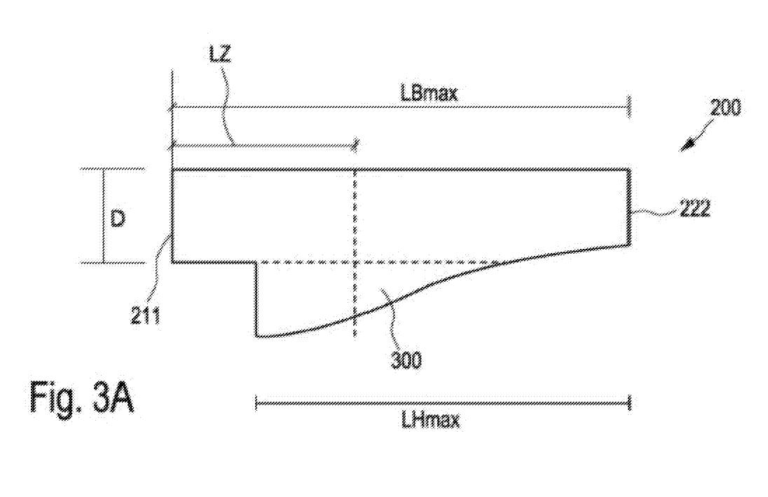

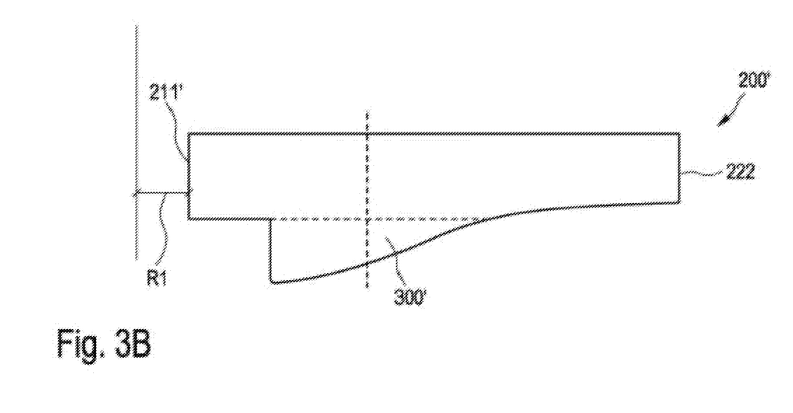

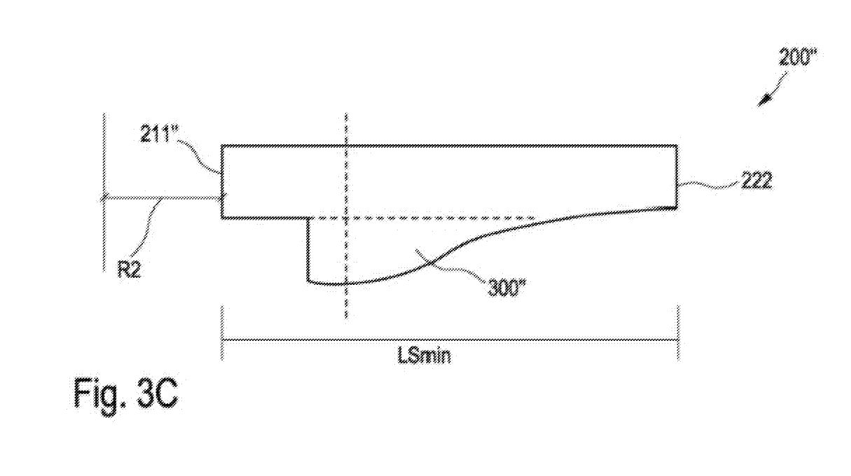

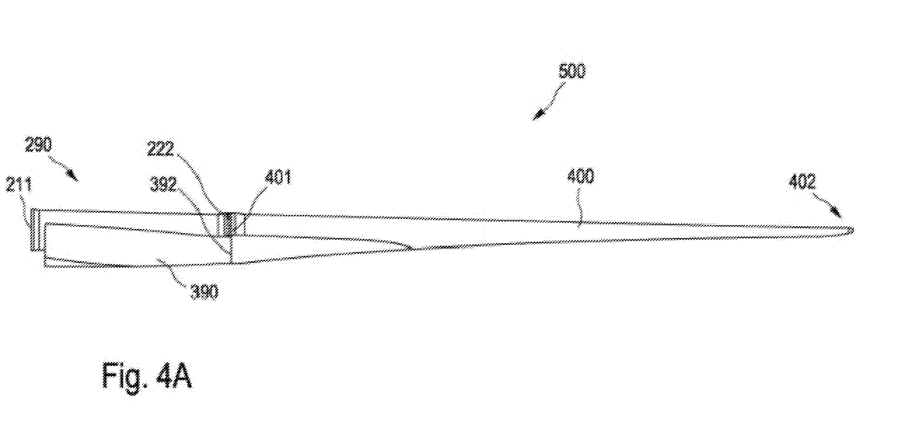

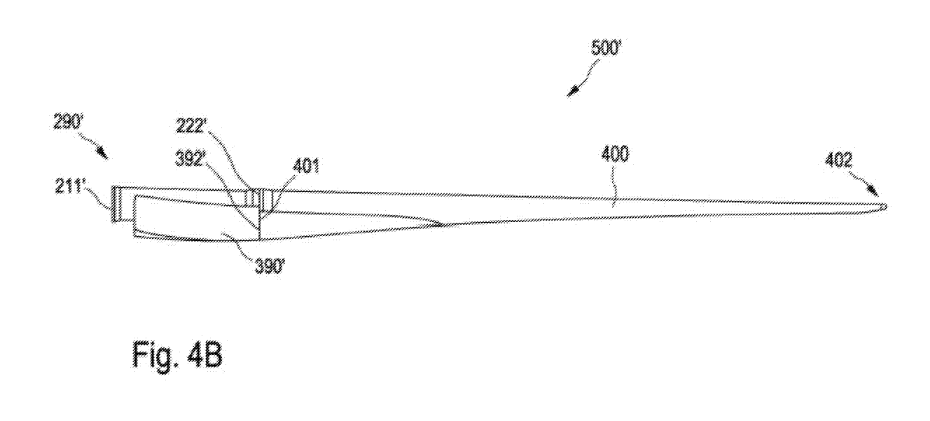

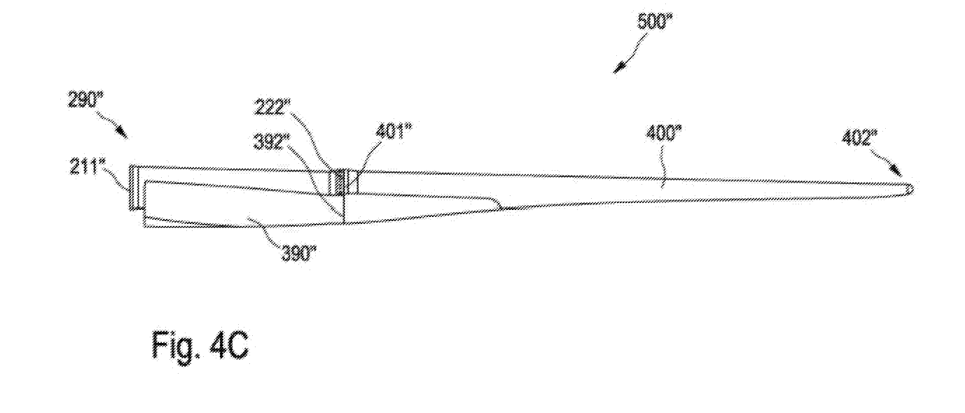

At least one of the rotor blades 1108, preferably all three rotor blades 1108, have been produced with a winding core according to FIG. 2A, 2B or 2C, have a blade end with a trailing edge segment according to FIG. 3A, 3B or 3C and/or correspond to a rotor blade according to FIG. 4A, 4B or 4C.

Represented in FIGS. 2A, 2B, 2C is a winding core 100, 100′, 100″, which in these three figures is varied. In FIGS. 3A, 3B, 3C, the blade ends 200, 200′, 200″ are represented with trailing edge segments 300, 300′, 300″, the blade ends 200, 200′, 200″ being produced by means of the variants of the winding core 100, 100′, 100″ according to FIGS. 2A, 2B, 2C. Represented in turn in FIGS. 4A, 4B, 4C are three rotor blades 500, 500′, 500″ with in each case a blade end 290, 290′, 290″, a trailing edge segment 390, 390′, 390″ and an outer blade 400, 400″, which form a rotor blade series.

In FIG. 2A, the winding core 100 has its maximum longitudinal extent LWmax. In FIG. 2B, the winding core 100′ is shortened by the amount R1 in comparison with the variant represented in FIG. 2A. In FIG. 2C, the winding core 100″ is shortened by the amount R2 in comparison with the variant represented in FIG. 2A. The variants of the winding core 100, 100′, 100″ represented in FIGS. 2A, 2B, 2C consequently differ in their longitudinal extent.

The winding core 100, 100′, 100″ has a first section 110, 110′, 110″ and a second section 120. The second section 120 has a first end 121 and a second end 122 opposite therefrom. The second section 120 has a longitudinal extent LA2.

The first end 121 of the second section 120 is connected to a second end 112 of the first section 110, 110′, 110″.

The second end 122 is used for forming an outer blade connection geometry of a blade end when winding around the winding core with a fiber composite material and a matrix material.

The winding core 100 represented in FIG. 2A is used for producing the blade end 200 represented in FIG. 3A. In FIG. 2, the winding core 100 has a completely present first section 110, which has its maximum longitudinal extent LA1max. A first end 111 of the first section 110 is used for producing a hub connection geometry 211 of the blade end 200. At the first end 111, the first section 110 has a diameter D, preferably an outer diameter.

The first section 110 also has four winding core segments 130, 140, 150, 160. The four winding core segments 130, 140, 150, 160 have in each case a first end 131, 141, 151, 161 and in each case a second end 132, 142, 152, 162. The second end 162 of the fourth winding core segment 160 forms at the same time the second end 112 of the first section 110. The first end 131 of the first winding core segment 130 forms at the same time the first end 111 of the first section 110. The winding core segments 130, 140, 150, 160 are detachably connected to the respectively neighboring winding core segment(s).

The winding core 100 represented in FIG. 2A can be used to create the blade end 200 represented in FIG. 3A, the longitudinal extent LBmax of which corresponds to the longitudinal extent LWmax of the winding core 100.

Preferably, the first section 110 is formed cylindrically, so as to produce a blade end 200 that has in this region LZ at least one cylindrical inner cavity.

The trailing edge segment 300 only extends over part of the longitudinal extent LBmax of the blade end 200.

The winding core 100′, which is represented in FIG. 2B, is used for producing the blade end 200′, which is represented in FIG. 3B. As can be seen in both figures, both the winding core 100′ and the blade end 200′ are shortened in their respective longitudinal extent by the amount R1 in comparison with the winding core 100 and the blade end 200 according to FIGS. 2A, 3A. This has been achieved by the first winding core segment 130 of the winding core 100 being removed. The extent in the longitudinal direction of the first winding core segment 130 thus corresponds to the degree of shortening R1.

The first end 111′ of the first section 110′ is formed in the case of the winding core 100′ by the first end 141 of the second winding core segment 140 and is used for forming the hub connection geometry 211′ of the blade end 200′.

The winding core 100″ represented in FIG. 2C is used for producing the blade end 200″ represented in FIG. 3C. The first end 111″ of the first section 110″ is formed in the case of the winding core 100″ by the first end 151 of the third winding core segment 150 and is used for forming the hub connection geometry 211″ of the blade end 200″.

In the case of a preferred cylindrical formation of the first section 110, 110′, 110″, a constant hub connection geometry 211, 211′ 211″ of the blade ends 200, 211′, 211″ is also obtained in an advantageous way. Since in the case of the embodiment represented here the second section 120 of the winding core 100, 100′, 100″ is not varied, the blade ends 200, 200′, 200″ also have a constant outer blade connection geometry 222.

The trailing edge segments 300, 300′, 300″ only extend over part of the longitudinal extent of the blade ends 200, 200′, 200″. The respective shape of the trailing edge segments 300, 300′, 300″, in particular a radial and/or tangential extent of the trailing edge segments 300, 300′, 300″ orthogonal to their longitudinal extent, is preferably adapted to the respective rotor blade design. In particular, it is preferred that the three trailing edge segments 300, 300′, 300″ are produced in a mold for producing trailing edge segments, as described herein. In particular, a preferred mold may be one in which a maximum size of a trailing edge segment 300, in particular a maximum longitudinal extent LHmax, can be produced, and which can be varied by exchanging and/or adding one or more mold segments in such a way that the trailing edge segments 300′, 300″ can also be produced with the same mold.

The rotor blade series represented in FIGS. 4A, 4B, 4C has three different rotor blades 500, 500′, 500″. The two rotor blades 500, 500′ have an identically formed outer blade 400 with a blade end connection geometry 401 and a blade tip 402. The rotor blades 500, 500′ differ by differently formed blade ends 290, 290′, which are connected by their outer blade connection geometries 222, 222′ to the blade end connection geometries 401 of the outer blades 400.

The rotor blades 500, 500′ also differ by differently formed trailing edge segments 390, 390′. In the embodiments shown in FIGS. 4A, 4B, 4C, the trailing edge segments 390, 390′, 390″ also have connection geometries 392, 392′, 392″, in order also to adapt the trailing edge segments 390, 390′, 390″ to the outer blades 400 visually and/or with respect to the shape and/or the connection geometry. The blade ends 290, 290′ differ primarily in their longitudinal extent. Preferably, the hub connection geometries 211, 211′ and the outer blade connection geometries 222, 222′ are in each case identically formed.

The third rotor blade 500″ differs from the first two rotor blades 500, 500′ not only by a differently formed blade end 290″ and a differently formed trailing edge segment 390″, but also by a different outer blade 400″. The outer blade 400″ has a shorter longitudinal extent than the outer blades 400. The blade end connection geometry 401″ may correspond to the blade end connection geometries 401 of the outer blades 400. The blade tip 402′ may also correspond to the blade tips 402 of the outer blades 400. The blade end connection geometry 401′ and/or the blade tip 402 may however also be formed differently from the blades 400.

Also the hub connection geometry 200″ and/or the outer blade connection geometry 222″ and/or the connection geometry 392″ may be formed identically to or differently from the corresponding geometries of the rotor blades 500, 500′.

Among the advantages of the various aspects of the invention, which lead inter alia to the rotor blade series, is that various rotor blades can be produced quickly, inexpensively and reliably. In this way, the expenditure on the design, the construction and/or the production of different rotor blades for wind power installations with different rotor diameters can be reduced.

1. A winding core for producing blade ends for rotor blades of wind power installations, the winding core comprising:
a first section having a first end for forming a hub connection geometry for connecting the blade end to a rotor hub; and
a second section having a second end for forming an outer blade connection geometry for connecting the blade end to an outer blade,
wherein a portion or all of the first section is removable to vary at least one of: a longitudinal length of the winding core, a diameter of the first section, or a shape of the first section, such that the winding core is configured to produce different shaped blade ends for wind power installations having different rotor diameters.

2. The winding core as claimed in claim 1, wherein when all of the first section is removed, a first end of the second section is configured for forming the hub connection geometry for connecting the blade end to the rotor hub.

3. The winding core as claimed in claim 1, wherein the first section includes a plurality of winding core segments, wherein the plurality of winding core segments form the portion that is removable to vary at least one of: the longitudinal length of the winding core, the diameter of the first section, or the shape of the first section.

4. The winding core as claimed in claim 3, wherein the plurality of winding core segments includes at least a first winding core segment and a second winding core segment, wherein in the event the first winding core segment is removed, a first end of the second winding core segment is used for forming the hub connection geometry.

5. The winding core as claimed in claim 1, wherein the second section has a first end that corresponds to the first end of the first section.

6. The winding core as claimed in claim 1, wherein the first section and the second section have rotational symmetry.

7. The winding core as claimed in claim 1, wherein the first section has an essentially cylindrical shape.

8. The winding core as claimed in claim 1, wherein the second section has an essentially cylindrical or essentially frustoconical shape.

9. A mold for producing trailing edge segments for rotor blades of wind power installations, the mold comprising:
a plurality of mold segments, wherein at least some of the plurality of mold segments are removable to vary at least one of: a longitudinal length of the mold, a shape of the mold, or a maximum dimension of the mold orthogonal to the longitudinal length in such a way that trailing edge segments produced by the mold are suitable for rotor blades for wind power installations with different rotor diameters.

10. A method for producing blade ends for rotor blades of wind power installations, the method comprising:
providing a winding core as claimed in claim 1;
winding fiber composite material and a matrix material onto the winding core; and
curing the matrix material.

11. A method for producing trailing edge segments for rotor blades of wind power installations, the method comprising:
providing a mold as claimed in claim 9;
introducing fiber composite material and matrix material into the mold; and
curing the matrix material.

12. A method for producing a rotor blade for a wind power installation, the method comprising:
providing a blade end that is produced using a winding core as claimed in claim 1; and
connecting the blade end to one or more attachment parts.

13. A rotor blade for a wind power installation, comprising a blade end that is produced using the winding core as claimed in claim 1 and further comprising a trailing edge segment coupled to the blade end.

14. A wind power installation, comprising at least one rotor blade as claimed in claim 13.

15. A rotor blade series for wind power installations, comprising:
a first blade end and a second blade end that are produced using the winding core as claimed in claim 1;
a first outer blade and a second outer blade;
the first blade end being connected to the first outer blade to form a first rotor blade, the second blade end being connected to the second outer blade to form a second rotor blade; and
the first rotor blade being suitable for a wind power installation with a first rotor diameter and the second rotor blade being suitable for a wind power installation with a second rotor diameter, the first rotor diameter being different from the second rotor diameter.

16. The winding core as claimed in claim 3, wherein the plurality of winding core segments each have a first end that correspond to the first end of the first section.

17. The winding core as claimed in claim 12, wherein the one or more attachment parts is at least one of: a trailing edge segment, an outer blade, or a blade tip.
